(19) United States
(12) Patent Application Publication
(10) Pub. No.: US 2023/0308957 A1
(43) Pub. Date: Sep. 28, 2023

(54) RESOURCE DISTRIBUTION SCHEMES IN WIRELESS COMMUNICATIONS

(71) Applicant: ZTE Corporation, Shenzhen (CN)

(72) Inventors: Yuan Gao, Shenzhen (CN); He Huang, Shenzhen (CN)

(21) Appl. No.: 18/326,399

(22) Filed: May 31, 2023

Related U.S. Application Data
(63) Continuation of application No. PCT/CN2021/081669, filed on Mar. 19, 2021.

(51) Int. Cl. H04W 36/00

(52) U.S. Cl. CPC H04W 36/0055

(57) ABSTRACT

A method of wireless communication is provided to include receiving, by a user device, from a network device, configuration information that is used to distribute, to the user device, resource elements that include beams, cells, or frequencies; and using, by the user device, the configuration information for a subsequent operation, wherein the configuration information includes at least one of i) one or more lists of distribution targets, ii) one or more distribution factors, each distribution factor giving a weight of a corresponding distribution target, or iii) a timer configured with the one or more distribution targets or the one or more distribution factors.

### CROSS REFERENCE TO RELATED APPLICATIONS

This patent document is a continuation of and claims benefit of priority to International Patent Application No. PCT/CN2021/081669, filed on Mar. 19, 2021. The entire content of the before-mentioned patent application is incorporated by reference as part of the disclosure of this application.

### TECHNICAL FIELD

This patent document generally relates to systems, devices, and techniques for wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices.

### SUMMARY

This document relates to methods, systems, and devices for resource distribution schemes in wireless communications.

In one aspect, a wireless communication method is disclosed to include receiving, by a user device, from a network device, configuration information that is used to distribute, to the user device, resource elements that include beams, cells, or frequencies; and using, by the user device, the configuration information for a subsequent operation, wherein the configuration information includes at least one of i) one or more lists of distribution targets, ii) one or more distribution factors, each distribution factor giving a weight of a corresponding distribution target, or iii) a timer configured with the one or more distribution targets or the one or more distribution factors.

In another aspect. A wireless communication method is disclosed to include transmitting, by a network device, to a user device, configuration information that is used to distribute, to the user device, resource elements that include beams, cells, or frequencies, and wherein the configuration information includes at least one of i) one or more lists of distribution targets, ii) one or more distribution factors, each distribution factor giving a weight on a corresponding distribution target, or iii) a valid timer configured with the one or more distribution targets or the one or more distribution factors.

These, and other features, are described in the present document.

### BRIEF DESCRIPTION OF THE DRAWINGS

FIG. 1 illustrates a flowchart showing a procedure between UE and network (NW) based on some implementations of the disclosed technology.

FIG. 2 illustrates a flowchart showing a procedure between UE and network (NW) based on some implementations of the disclosed technology.

FIG. 3 illustrates a flowchart showing a procedure between UE and network (NW) based on some implementations of the disclosed technology.

FIG. 4 illustrates a flowchart showing a procedure between UE and network (NW) based on some implementations of the disclosed technology.

FIG. 5 shows an example of a dynamic switch among cells.

FIG. 6 illustrates a flowchart showing a procedure between UE and network (NW) based on some implementations of the disclosed technology

FIG. 7 shows an example of a dynamic switch among cells.

FIG. 8 illustrates a flowchart showing a procedure between UE and network (NW) based on some implementations of the disclosed technology

FIG. 9 shows an example of wireless communication including a base station (BS) and user equipment (UE) based on some implementations of the disclosed technology.

FIG. 10 shows an example of a block diagram of a portion of an apparatus based on some implementations of the disclosed technology.

FIGS. 11 and 12 show examples of a method for wireless communication based on some implementations of the disclosed technology.

### DETAILED DESCRIPTION

The disclosed technology provides implementations and examples of distributing schemes for a user device in wireless communications.

During the existing cell reselection process, UE (user equipment) is reselect to the strongest cell in the highest priority frequency based on the existing cell reselection procedures in NR. To find the strongest cell, UE ranks cells on the frequencies with equal priority by the measured RX and the quality. For a cell, its cell level RX (receiver) value and quality is derived based on the beam level measurement results of several best beams. As a result, UE will gather the best beams of the strongest cell in the highest priority frequency without making full use of other beams, cells, and frequencies. In addition, following the cell reselection procedure, UE may camp on a neighbor cell deployed by a different operator (identified by PLMN) while the operator would prefer UE to stay in the cells deployed by its registered PLMN. In recognition of the issues of the existing cell reselection process, the disclosed technology provide implementations and examples of distributing users among beams, cells, and/or frequencies or guiding UE to cells deployed by certain PLMNs during the cell reselection procedure.

Redistribution in LTE

In LTE, UE is reselect to the strongest cell in the highest priority frequency. To find the strongest cell, UE will rank cells on the frequencies with equal priority by the measured RX and the quality. As a result, UE will gather on the strongest cell on certain frequencies with high priority. To distribute UE among cells and frequencies evenly, a redistribution procedure has been introduced in LTE. Based on the redistribution procedure, a UE may be redistributed to a redistribution target (frequency or cell) and will consider the redistribution target (frequency or cell) as having the highest priority (i.e. higher than any network configured priority) for a period of time (i.e. validity timer). The redistribution parameters are defined in system information and can be triggered by paging or by UE when the redistribution is configured.

The UE shall compile a sorted list of one or more candidate redistribution targets, and for each candidate entry [j] a valid redistrFactor[j], in which entries are added in increasing index order starting with index 0 as follows:
for the serving frequency (redistributionFactorServing is included in SystemInformationBlockType3 whenever redistribution is configured):
the serving cell if redistributionFactorCell is included;
otherwise the serving frequency;
In both cases, redistrFactor[0] is set to redistributionFactorServing;
for each entry in InterFreqCarrierFreqList and subsequent for each entry in InterFreqCarrierFreqListExt:
the cell ranked as the best cell on this frequency according to clause 5.2.4.6 if redistributionNeighCellList is configured and includes this cell;
otherwise, the concerned frequency if redistributionFactorFreq is configured and if at least one cell on the frequency fulfills the cell selection criterion S defined in 5.2.3.2;
If the cell is included, redistrFactor[j] is set to the corresponding redistributionFactorCell; If the frequency is included, redistrFactor[j] is set to the corresponding redistributionFactorFreq;

The UE shall choose a redistribution target as follows:
If ueID≤200·redistrRange[0], the UE shall choose the frequency or the cell corresponding to redistrFactor[0] as its redistribution target or;
If 200·Σⱼ₌₀^{j=1} redistrRange[f]≤ueID≤200·Σⱼ₌₀^{j=i+1} redistrRange[j], then the UE shall choose the frequency or cell corresponding to redistrFactor[i] as its redistribution target;
ueID=(IMSI mod 100)?2+1;

If there are no redistribution candidates apart from the serving frequency or cell, the redistrRange[0]=1.

Otherwise, the redistrRange[i] of E-UTRAN frequency or cell is defined by:

$$redistr Range [ i ] = \frac{redistr Factor [ i ]}{{\sum }_{j = 0}^{j = ( maxCandidates - 1 )} redistr Factor [ j ]}$$

Where: maxCandidates is the total number of frequencies/cells with valid redistrFactor[j].

Cell Quality Derivation in NR

For a cell reselection in multi-beam operations, the measurement quantity of a cell is derived amongst the beams corresponding to the same cell based on SS/PBCH block as follows:
if nrofSS-BlocksToAverage is not configured in SIB2/SIB4; or
if absThreshSS-BlocksConsolidation is not configured in SIB2/SIB4; or
if the highest beam measurement quantity value is below or equal to absThreshSS-BlocksConsolidation:
derive a cell measurement quantity as the highest beam measurement quantity value, where each beam measurement quantity is described in TS 38.215 [11].
else:
derive a cell measurement quantity as the linear average of the power values of up to nrofSS-BlocksToAverage of highest beam measurement quantity values above absThreshSS-BlocksConsolidation.

Based on the existing cell reselection procedure in NR, the UE is still reselected to the strongest cell in the highest priority frequency. To find the strongest cell, UE will rank cells on the frequencies with equal priority by the measured RX and the quality. For a cell, its cell level RX value and quality is derived based on the beam level measurement results of several best beams. As a result, UE will gather on the best beams of the strongest cell in the highest priority frequency, without making full use of the other beams, cells and frequencies. In addition, following the existing cell reselection procedure, UE may camp on a neighbor cell deployed by a different operator (identified by PLMN) while the operator would prefer UE to stay in the cells deployed by its registered PLMN.

Various implementations of the disclosed technology suggest schemes for distributing beams, cells and frequencies to UE or guiding UE to cells deployed by certain PLMNs during the cell reselection procedure.

Distribution Configuration rom Network

In some implementations, UE receives the distribution configuration from network and derive cell measurement quantity and/or select distribution target based on the received distribution configuration.
STEP 1: UE receives the distribution configuration from network.
STEP 2: UE derives cell measurement quantity and/or select distribution target based on the received distribution configuration.

In some implementations, the distribution configuration may include distribution targets, distribution factor for each distribution target, and/or a time(r) of the distribution targets and the corresponding distribution factors. In some implementations, the distribution configuration further includes an indication indicating whether the distribution can be triggered by UE itself or by network (NW). Each item is to be discussed in more detail in the below.

Item 1: Distribution Targets

One or more lists of distribution targets can be provided from the network. In some implementations, a distribution target can be a beam, cell, cell group or a frequency. The distribution target as a beam is identified by reference signal, e.g. SS/PBCH, or CSI-RS. The distribution target as a cell is identified as a physical cell id or a Cell Global Identifier. The distribution target as a frequency is identified as a ARFCN value.

In some implementations, more than one lists of distribution targets can be configured and each list of distribution targets is for a certain slice (identified by S-NSSAI or part of the S-NSSAI), slice group (identified by a slice group id), access category (identified by accessCategory), access category group (identified by a access category id), SNPN (identified by PLMN ID+NID), PLMN (identified by a PLMN ID) or a CAG (identified by a PLMN ID+CAG ID).

In some implementations, one or more lists of distribution targets can be configured for a certain network type or a certain network scenario, e.g., SNPN network, CAG network, NPN network, terrestrial network, non-terrestrial network, non-terrestrial network served by GEO satellite, non-terrestrial network served by non-GEO satellite, non-terrestrial network served by MEO satellite, non-terrestrial network served by LEO satellite, non-terrestrial network served by HAPS, non-terrestrial network with fixed beam scenario or non-terrestrial network with moving beam scenario.

In some implementations, the distributions targets can be provided to UE via SIB1/SIB2/SIB3/SIB4 or in a newly introduced SIB or via dedicated RRC signaling, e.g. RRCRelease, RRCResume, or RRCReconfiguration message.

Item 2: One or More Distribution Factors for Each Distribution Target.

For the same distribution target, one or more distribution factors can be configured. When more than one distributions factors are configured, each distribution factor gives a corresponding weight to a certain slice, slice group, access category, access category group, SNPN, PLMN, CAG or a certain network type/network scenario. The distribution factors can be provided to UE via SIB1/SIB2/SIB3/SIB4 or in a newly introduced SIB or via dedicated RRC signaling, e.g. RRCRelease, RRCResume, or RRCReconfiguration message.

One or more distribution targets as beams identified by reference signalings, e.g. SS/PBCH or CSI-RS with the distribution factors can be configured for a cell (the serving cell or neighbour cell), a frequency (the serving frequency or other frequencies) or a measurement object.

Item 3: Timer

A time(r) can be configured together with the distribution targets and factors. The timer is started at UE side upon reception of the distribution configuration or upon NW indicating to trigger the distribution.

Item 4: Indication Indicating Element Triggering Distribution

In some implementations, the distribution configuration may include an indication indicating whether the distribution can be triggered by UE itself or by network (NW). One or more such indications can be configured. When more than one such indications are configured, each indication indicates whether a certain slice, slice group, access category, access category group, SNPN, PLMN, CAG or a certain network type/network scenario allows UE to trigger distribution by itself or the distribution can only be triggered by NW.

In some implementations, the indication can be a bitmap for a list of slices, slice groups, access categories, access category groups, SNPNs, PLMNs, NPNs or CAGs. The first/leftmost bit is for the first slice/slice group/access category/access category group/SNPN/PLMN/CAG with Value I/O showing that the distribution can only be triggered by NW while value 0/1 showing that UE can trigger the distribution operation itself after the configuration is provided.

In some implementations, the indication can also be configured as a ENUMERATED value for a S-NSSAI, a slice group id, an accessCategory, an access category group id, a PLMN ID+NID, a PLMN ID+CAG ID or a PLMN ID.

In some implementations, the indication can be a bitmap for a list of network types or network scenarios with each bit indicating whether UE can trigger the distribution operation itself after the configuration is provided for this network type or scenario. The indication can also be configured as a ENUMERATED value for a certain network type or scenario.

Such indications can be broadcast to UE in SIB1/SIB2/SIB3/SIB4 or in a newly introduced SIB or be provided to UE via dedicated RRC signaling, e.g. RRCRelease, RRCResume, RRCReconfiguration message.

In some implementations, the network may trigger the distribution operation. For example, NW can trigger the distribution operation at UE by a distribution triggering indication. This distribution triggering indication can be a one-bit indication to trigger distribution procedure and UE can take all the configured distribution targets into consideration. This distribution triggering indication can be a list of indications and each indication is used to trigger distribution under a certain slice, slice group, access category, access category group, SNPN, PLMN, CAG, NPN or a certain network type/network scenario. In some implementations, UE will only consider the distribution targets for certain slices, slice groups, access categories, access category groups, SNPNs, PLMNs, CAGs or certain network types/network scenarios, for which NW triggers a distribution procedure. This distribution triggering indication can also be sent for normal uplink (NUL) and/or Supplementary Uplink (SUL) separately, for the case when the NUL or SUL or both NUL and SUL are overloaded. In some implementations, the distribution triggering indication can be implemented as two ENUMERATED values 0/1 including one for NUL and the other for SUL. In some implementations, the distribution triggering indication can be implemented as a 2 bit bitmap including a first (or leftmost) bit for NUL and a second (or rightmost) bit for SUL. In some implementations, the distribution triggering indication can be indicated using a distribution cause with ENUMERATED values, e.g. “SUL overloaded, NUL overloaded, both SUL and UL overloaded, DL overloaded, UL overloaded”.

A bitmap can be introduced for a list of slices, slice groups, access categories, access category groups, SNPNs, PLMNs, CAGs, NPNs, network types, or network scenarios. The first/leftmost bit is for the first slice/slice group/access category/access category group/SNPN/PLMN/CAG/NPN/network type/scenario with Value I/O to trigger a distribution procedure at UE side.

In some implementations, a distribution procedure at UE side can be triggered by a ENUMERATED value set to “true” for a certain slice, slice group, access category, access category group, SNPN, PLMN, CAG, NPN or a certain network type/network scenario.

In some implementations, NW can trigger the distribution operation at UE side via DCI or a paging message or a dedicated RRC message, e.g. RRCRelease, RRCResume, RRCReconfiguration message or a MAC CE. The DCI to trigger distribution can either be a paging DCI or a DCI introduced specially for triggering the distribution. The distribution triggering indication can be included in Short message in paging DCI or in the paging message.

UE's Behavior Upon Reception of Distribution Configuration

If the distribution procedure is allowed to be triggered by UE itself, UE will trigger the distribution upon reception of the distribution configuration. In some implementations, UE will trigger distribution procedure for certain slices, slice groups, access categories, access category groups, SNPNs, PLMNs, CAGs, NPNs, network types, or network scenarios upon reception of the distribution configuration when NW allows UE to trigger the distribution by UE itself for these slices, slice groups, access categories, access category groups, SNPNs, PLMNs, CAGs, NPNs, network types, or network scenarios.

If the distribution procedure can only be triggered by NW, UE will trigger the distribution procedure upon reception of NW indication. In some implementations, UE will trigger distribution procedure for certain slices, slice groups, access categories, access category groups, SNPNs, PLMNs, CAGs, NPNs, network types, or network scenarios when NW indicate to trigger distribution for these slices, slice groups, access categories, access category groups, SNPNs, PLMNs, CAGs, NPNs, network types, or network scenarios. In some implementations, when NW indicates to trigger distribution for SUL or NUL, UE will check the rsrp-ThresholdSSBSUL and decide whether to trigger the distribution. For example, if NW indicates to trigger distribution for SUL (e.g. when the SUL is overloaded), UE evaluates the RSRP of the downlink pathloss reference and triggers the distribution procedure based on the evaluated RSRP. For example, UE will trigger the distribution procedure when UE finds the evaluated RSRP is less than rsrp-ThresholdSSB-SUL (i.e. SUL will be selected when initiating random access), and otherwise, UE will not trigger the distribution procedure and stay in the current cell as NUL will be selected for random access. In some implementations, NW indicates to trigger distribution for SUL (e.g. when SUL is overloaded), UE will select NUL. In some implementations, NW indicates to trigger distribution for NUL (e.g. when NUL is overloaded), UE will select SUL. In some implementations, NW indicates to trigger distribution for SUL or NUL, UE will apply the distribution factor configured for the SUL carriers/frequencies or NUL carriers/frequencies identified by ARFCN.

In some implementations, the distribution procedure compromises: derivation of the cell measurement quantity distribution target selection, sending measurement report, performing cell selection and reselection, evaluating conditional handover/conditional PSCell change condition, or determining the target for a cell switch or a cell group switch. The distribution procedure can be performed by UE in idle/inactive/connected mode.

For the case when the distribution target is a beam identified by reference signals, e.g. SSB or CSI-RS, the distribution factor for a SS/PBCH block (SSB)/CSI-RS can be configured. For example, a distribution factor list can be configured such that the first distribution factor in the list is for the SS/PBCH index 0/CSI-RS index 0, the second distribution/weight factor is for SS/PBCH index 1/CSI-RS index 1 and so on. In another example, to the distribution factor can be provided with SS/PBCH index/CSI-RS index.

Upon receiving the distribution factor for each SSB/CSI-RS and being allowed or triggered to perform the distribution (e.g., NW allows UE to trigger the distribution operation by UE itself or NW indicates that the distribution operation can only be triggered by NW and NW indicates to trigger the operation), UE will multiply the beam measurement quantity value of the reference signal, e.g. SSB/CSI-RS, with the corresponding distribution factor. UE derives the cell measurement quantity based on the multiplication of the beam measurement quantity value and the corresponding distribution factor and uses the derived cell measurement quantity. The derived cell measurement result can be used in following manners:

In some implementations, UE will use the cell measurement results to select or reselect a cell during a cell selection and/or a reselection procedure. For example, the S-criterion or R-criterion is evaluated. After selecting or reselecting of the cell, UE may trigger data transmission (e.g., small data transmission).

In some implementations, UE may use the cell measurement results in measurement report. In some implementations, an indication is added in the measurement report to indicate to NW that the distribution factor has been considered in the cell level measurement quantity derivation.

In some implementations, UE may use the cell measurement results to evaluate the execution condition for conditional handover or conditional PSCell change.

In some implementations, UE may use the cell measurement results to determine a target for cell/cell group switch procedure. The cell switch or cell group switch refers to the procedure that UE changes the serving cell or cell group or the components of the serving cell group and activates these cells. Such procedure can be triggered by UE itself after selecting a target or triggered by NW before or after the target is selected.

For the case when the distribution targets along with distribution/weight factors as beams identified by reference signals, e.g. SS/PBCH or CSI-RS, are configured separately for different slices, slice groups, access categories, access category groups, SNPNs, PLMNs, CAGs, NPNs, network types, or network scenarios, UE will apply the distribution/weight factor for a certain beam for the corresponding slice/slice group/access category/access category group/SNPN/PLMN/CAG/NPN/network type/network scenario.

| | | |
|---|---|---|
| PLMN #1 | SSB index 0 | distribution/weight factor #1 |
| | SSB index 1 | distribution/weight factor #2 |
| PLMN #2 | SSB index 2 | distribution/weight factor #3 |
| | SSB index 3 | distribution/weight factor #4 |
| PLMN #3 | SSB index 4 | distribution/weight factor #5 |
| | SSB index 5 | distribution/weight factor #6 |

For the case when different distribution/weight factors are configured for the same distribution target as a beam for different slices, slice groups, access categories, access category groups, SNPNs, PLMNs, CAGs, NPNs, network types, or network scenarios, UE will apply the corresponding distribution/weight factor for this beam for the corresponding slice/slice group/access category/access category group/SNPN/PLMN/CAG/NPN/network type/network scenario.

| | | |
|---|---|---|
| PLMN #1 | SSB index 0 | distribution/weight factor #1 |
| | SSB index 1 | distribution/weight factor #2 |
| PLMN #2 | SSB index 0 | distribution/weight factor #3 |
| | SSB index 1 | distribution/weight factor #4 |
| PLMN #3 | SSB index 0 | distribution/weight factor #5 |
| | SSB index 1 | distribution/weight factor #6 |

For the case when the distribution target is a cell, upon receiving the distribution/weight factor for each cell and NW allows UE to trigger the distribution operation by UE itself or NW indicates that the distribution operation can only be triggered by NW and NW indicates to trigger the operation, UE will multiplex the cell RX/quality value (e.g. the RSRP/RSRQ) with the corresponding distribution/weight factor to derive the final cell measurement results. UE will then use the cell level measurement results with the distribution/weight factor considered during cell selection and reselection procedure, e.g. when the S-criterion or R-criterion is evaluated. After selecting or selecting of a cell, UE may trigger data transmission (e.g., small data transmission). UE may also use the cell level measurement results with the distribution/weight factor considered in measurement report. And an indication is added in the measurement report to indicate to NW that the distribution/weight factor per cell has been considered in the cell level measurement quantity derivation. UE may also use the cell level measurement results with the distribution/weight factor considered when evaluate the execution condition for conditional handover or conditional PSCell change. UE may also use the cell level measurement results with the distribution/weight factor considered when determine the target for cell/cell group switch.

For the case when the distribution targets along with distribution/weight factors as cells are configured separately for different slices, slice groups, access categories, access category groups, SNPNs, PLMNs, CAGs, NPNs, network types, or network scenarios, UE will apply the distribution/weight factor for a certain cell for the corresponding slice/slice group/access category/access category group/SNPN/PLMN/CAG/NPN/network type/network scenario.

For the case when different distribution/weight factors are configured for the same distribute target as a cell for different slices, slice groups, access categories, access category groups, SNPNs, PLMNs, CAGs, NPNs, network types, or network scenario s, UE will apply the corresponding distribution/weight factor for this cell for the corresponding slice/slice group/access category/access category group/SNPN/PLMN/CAG/NPN/network type/network scenario.

For the case when the distribution target is a cell or a frequency, upon receiving the distribution/weight factor for each cell/frequency and NW allows UE to trigger the distribution operation by UE itself or NW indicates that the distribution operation can only be triggered by NW and NW indicates to trigger the operation, the UE shall compile a sorted list of one or more candidate distribution targets of one or more candidate distribution targets and for each candidate [j] a valid distrFactor[j], in which entries are added in increasing index order starting with index 0 as follows:
The candidate [0] can either be the serving cell (for the case that NW configures distribution factor for the serving cell) or the serving frequency (for the case that NW configures distribution factor for the serving frequency.
The candidate [j] refers to the j-th cell or frequency for which NW has configured distribution factor.

The UE shall choose a distribution target as follows:
If ueID 200≤distriRange[0], the UE shall choose the frequency or the cell corresponding to redistrFactor[0] as its redistribution target or;
If 200*Σⱼ₌₀^{j=i+1} distrRange[j]<ueID<200*Σⱼ₌₀^{j=i} distrRange[j], then the UE shall choose the frequency or cell corresponding to distrFactor[i] as its redistribution target;
ueID=(5G−S−TMSI mod 100)*2+1

If there are no distribution candidates apart from the serving frequency or cell, the redistrRange[0]=1.

Otherwise, the redistrRange[i] of E-UTRAN frequency or cell is defined by:

$$redistr Range [ i ] = \frac{redistr Factor [ i ]}{{\sum }_{j = 0}^{j = ( maxCandidates - 1 )} redistr Factor [ j ]}$$

Where: maxCandidates is the total number of frequencies/cells with valid distrFactor[j].

For the distribution target chosen by UE, UE will consider the distribution target (frequency or cell) as having the highest priority (i.e. higher than any network configured priority) for a period of time during the cell selection and/or reselection procedures. For the case that the distribution can only be triggered by NW, UE starts Txxx upon receiving the paging message/DO/dedicated RRC message/MAC CE to trigger the distribution procedure and set the value to txxx received in distribution configuration. For the case that the distribution can be triggered by UE itself, UE starts Txxx and set the value to txxx upon reception of the distribution configuration in which the txxx is included. The redistribution target is considered as the highest priority before the Txxx expires. After selecting or selecting of a cell, UE may trigger data transmission (e.g., small data transmission).

For the case when the distribution targets along with distribution/weight factors as cells or frequencies are configured separately for different slices, slice groups, access categories, access category groups, SNPNs, PLMNs, CAGs, NPNs, network types, or network scenarios, UE will apply the distribution/weight factor for a certain cell/frequency for the corresponding slice/slice group/access category/access category group/SNPN/PLMN/CAG/network type/network scenario.

For the case when different distribution/weight factors are configured for the same distribute target as a cell/frequency for different slices, slice groups, access categories, access category groups, SNPNs, PLMNs, CAGs, network types, or network scenarios, UE will apply the corresponding distribution/weight factor for this cell/frequency for the corresponding slice/slice group/access category/access category group/SNPN/PLMN/CAG/NPN/network type/network scenario.

### Implementation Example 1

The distribution factor is configured for each beam identified by reference signals, e.g. SSB index or CSI-RS resources. NW allows UE to trigger the distribution by itself after the distribution configuration is provided.

ASN.1 Example 1-1: The distribution factors for SSB are configured per cell.

```
DistributionInfo ::=  SEQUENCE (SIZE (1..maxSSB)) OF
DistributionInfoPerSSB
DistributionInfoPerSSB ::=  SEQUENCE {
  distributionFactor  ENUMERATED {oDot2, oDot4, oDot6, oDot8}
    OPTIONAL
}
```

The first DistributionInfoPerSSB in the DistributionInfo refers to the distribution factor configured for SSB index 0. If the distributionFactor is present for a SSB, UE will multiply the beam measurement quantity with the configured factor in cell measurement quantity derivation. Otherwise, no distribution factor will be applied in cell measurement quantity derivation.

ASN.1 Example 1-2: The distribution factors for SSB are configured per cell.

| | |
|---|---|
| DistributionInfo ::= | SEQUENCE (SIZE (1..maxSSB)) OF |
| DistributionInfoPerSSB | |
| DistributionInfoPerSSB ::= | SEQUENCE { |
| ssbIndex | INTEGER (0..maxSSB-1), |
| distributionFactor | ENUMERATED {oDot2, oDot4, oDot6, |
| | oDot8} |
| } | |

For a SSB (identified by ssbIndex), if the distribution factor is configured, UE will multiply the beam measurement quantity with the configured factor in cell measurement quantity derivation.

For example, the following distribution factors are configured:

| SSB index | Distribution factor |
|---|---|
| SSB index #0 | 0.4 |
| SSB index #1 | 0.8 |

Since the SSB index #0 has the highest beam measurement quantity value and nrofSS-BlocksToAverage is not configured in SIB2/SIB, the multiplication of the beam measurement quantity for SSB index #0 and the distribution factor (0.4) will be used to derive the cell measurement quantity value. Thus, the cell measurement quantity is derived based on the multiplication of 0.4 and the beam measurement quantity. The cell measurement quantity will be used in sending measurement report, performing cell selection and reselection, evaluating conditional handover/conditional PSCell change condition, or determining the target for cell switch or cell group switch. After selecting or reselection of a cell, UE may trigger data transmission (e.g., small data transmission).

For all the ASN.1 examples mentioned above, the distribution factor can also be configured per CSI-RS resource id, per CSI-RS resource set id or per CSI-RS index.

### Implementation Example 2

The distribution factor can be configured for each beam identified by reference signal, e.g. SSB index or CSI-RS resources per PLMN. The following table show an example of the distribution factor configured for each beam by SSB index per PLMN.

| PLMN | SSB | distribution factor |
|---|---|---|
| PLMN #1: | SSB index 0 | 0.2 |
| distributionOnPagingOnly | SSB index 1 | 0.8 |
| PLMN #2 | SSB index 0 | 0.4 |
| | SSB index 1 | 0.2 |
| PLMN #3 | SSB index 0 | 0.8 |
| distributionOnPagingOnly | SSB index 1 | 0.8 |

NW indicates that the distribution can only be triggered by paging for certain PLMNs. The following table shows an example of the distribution indication included in the paging message.

Distribution indication in the paging message

| | |
|---|---|
| PLMN #1 | Yes (indicated by “true” or “1” in a bitmap) |
| PLMN #3 | No |

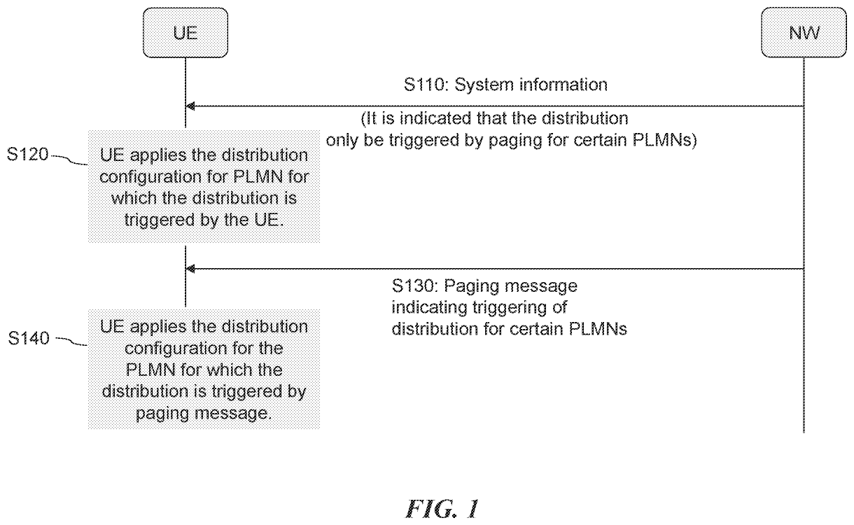

FIG. 1 illustrates a flowchart showing a procedure between UE and network (NW) based on some implementations of the disclosed technology.

At Step 1 (S110 in FIG. 1), UE receives the system information from NW. The system information includes the DistributionInfoPerPLMNList which is used to indicate that the distribution for certain PLMN (e.g. PLMN #1 and PLMN #3) can only be triggered by paging.

At Step 2 (S120 in FIG. 1), upon receiving the system information from NW, UE applies the distribution configuration to perform the distribution for the PLMN for which the distribution can be triggered by the UE. In this example, since the distribution for PLMN #2 can be triggered by UE itself, both nrofSS-BlocksToAverage and absThreshSS-BlocksConsolidation are configured and SSB #0 and SSB #1 are selected as good beams based on the absThreshSS-BlocksConsolidation. UE will use 0.4* the beam measurement quantity for SSB #0 and 0.2*the beam measurement quantity for SSB #1 in cell measurement quantity derivation.

At Step 3 (S130 in FIG. 1), NW triggers distribution for PLMN #1 via paging message.

At Step 4 (S140 in FIG. 1), the UE applies the distribution configuration to perform the distribution for the PLMN for which distribution operation is triggered by the paging message received at Step 3. Since both nrofSS-BlocksToAverage and absThreshSS-BlocksConsolidation are configured and SSB #0 and SSB #1 are selected as good beams based on the absThreshSS-BlocksConsolidation, for PLMN #1, UE will use 0.2* the beam measurement quantity for SSB #0 and 0.8*the beam measurement quantity for SSB #1 in cell measurement quantity derivation. Thus, the cell measurement quantity derivation is performed to obtain the cell measurement quantity by using the multiplication of the beam measurement quantity for each SSB and the corresponding distribution factor. The cell measurement quantity will be used in sending measurement report, performing cell selection and reselection, evaluating conditional handover/conditional PSCell change condition, or determining the target for cell switch or cell group switch. After selecting or reselecting of a cell, UE may trigger data transmission (e.g., small data transmission).

ASN.1 Example 2-1: The distribution factors for SSB are configured per PLMN. Different PLMNs can configure different SSBs with different distribution factors.

DistributionInfoPerPLMNList ::= SEQUENCE (SIZE (1..maxPLMN))
OF DistributionInfoPerPLMN
DistributionInfoPerPLMN ::= SEQUENCE (SIZE (1..maxSSB)) OF
DistributionInfoPerSSB
DistributionInfoPerSSB ::= SEQUENCE {
distributionFactor ENUMERATED {oDot2,
oDot4, oDot6, oDot8} OPTIONAL
}

ASN.1 Example 2-2: The distribution factors for SSB are configured per PLMN. Different PLMNs can configure different SSBs with different distribution factors.

```
DistributionInfoPerPLMNList ::= SEQUENCE (SIZE (1..maxPLMN))
OF DistributionInfoPerPLMN
DistributionInfoPerPLMN ::= SEQUENCE (SIZE (1..maxSSB) ) OF
DistributionInfoPerSSB
DistributionInfoPerSSB ::=  SEQUENCE {
  ssbIndex  INTEGER (0..maxSSB-1) ,
  distributionFactor  ENUMERATED {oDot2, oDot4, oDot6, oDot8}
}
```

For all the ASN.1 examples mentioned above, the distribution factor can also be configured per CSI-RS resource id, per CSI-RS resource set id or per CSI-RS index for each PLMN.

ASN.1 Example 2-3: The indication showing that the distribution can only be triggered by paging for certain PLMNs.

| | |
|---|---|
| distrOnPagingOnlyBitmap | BIT STRING (SIZE (1...maxPLMN)) |

The first/leftmost bit in this bitmap refers to the first PLMN in plmn-IdentityList, the second bit refers to the second PLMN in plmn-IdentityList, and so on. Value 1 indicates that distribution can only be triggered by paging for the corresponding PLMN.

ASN.1 Example 2-4:The indication showing that the distribution can only be triggered by paging for certain PLMNs.

DistrOnPagingPerPLMNList ::= SEQUENCE (SIZE (1..maxPLMN))
OF DistrOnPagingPerPerPLMN
DistrOnPagingPerPerPLMN ::= SEQUENCE {
distronPagingPerPerPLMN ENUMERATED {true} OPTIONAL
}

The first DistrOnPagingPerPerPLMN in the DistrOnPagingPerPLMNList refers to the first PLMN in plmn-IdentityList, the second DistrOnPagingPerPerPLMN refers to the second PLMN in plmn-IdentityList, and so on. For a certain PLMN with the distrOnPagingPerPerPLMN set to true, the distribution can only be triggered by paging.

ASN.1 Example 2-5:The indication showing that the distribution can only be triggered by paging for certain PLMNs.

```
DistrOnPagingPerPLMNList ::= SEQUENCE (SIZE (1..maxPLMN))
OF DistrOnPagingPerPerPLMN
DistrOnPagingPerPerPLMN ::= SEQUENCE {
  plmn-Index INTEGER (1..maxPLMN)
  distrOnPagingPerPerPLM ENUMERATED {true}
}
```

plmn-Index with value 1 refers to the first PLMN in plmn-IdentityList, the second bit refers to the second PLMN in plmn-IdentityList, and so on. For a certain PLMN with the distrOnPagingPerPerPLMN set to true, the distribution can only be triggered by paging.

ASN.1 Example 2-6:The indication showing that the distribution can only be triggered by paging for certain PLMNs.

DistrOnPagingPerPLMNList ::= SEQUENCE (SIZE (1..
maxPLMN)) OF DistrOnPagingPerPLMN

| | |
|---|---|
| DistronPagingPerPLMN ::= | SEQUENCE { |
| plmn-Identity | PLMN-Identity |
| distrOnPagingPerPLM | ENUMERATED {true} |
| PLMN-Identity ::= | SEQUENCE { |
| mcc | MCC OPTIONAL, - |
| - Cond MCC | |
| mnc | MNC |
| } | |
| MCC ::= | SEQUENCE (SIZE (3)) OF MCC-MNC-Digit |
| MNC ::= | SEQUENCE (SIZE (2..3)) OF MCC-MNC- |
| | Digit |
| MCC-MNC-Digit ::= | INTEGER (0..9) |

The PLMN-Identity is the global id of a PLMN. For a PLMN identified by PLMN-Identity, if the distrOnPagingPerPLMN is set to true, the distribution for this PLMN can only be triggered by paging.

ASN.1 Example 2-7:The indication in paging message to trigger the distribution.

| | |
|---|---|
| Paging ::= | SEQUENCE { |
| distributionIndicationPerPLMNlist | SEQUENCE (SIZE (1..maxPLMN)) |
| OF DistributionIndicationPerPLMN | |
| } | |
| DistributionIndicationPerPLMN ::= | SEQUENCE { |
| plmn-Index | INTEGER (1..maxPLMN) |
| distriIndicationPerPLMN | ENUMERATED {true} |
| } | |

In the paging message, if the DistributionIndicationPerPLMN is present and set to true for a certain PLMN, it indicates to trigger distribution procedure (i.e. UE use the distribution factor for each beam in cell measurement quantity derivation) for this PLMN.

ASN.1 Example 2-8:The indication in paging message to trigger the distribution.

| | |
|---|---|
| Paging : := | SEQUENCE { |
| distriIndicationBitmap | BIT STRING (SIZE |
| (1 ... maxPLMN)) OPTIONAL | |
| } | |

The first/leftmost bit in this bitmap refers to the first PLMN broadcast in plmn-IdentityList, the second bit in this bitmap refers to the second PLMN, and so on. For a certain PLMN, value “1” of the corresponding bit indicates to trigger distribution procedure (i.e. UE use the distribution factor for each beam in cell measurement quantity derivation) for this PLMN.

### Implementation Example 3

The distribution factor is configured for each beam identified by reference signals, e.g. SSB index or CSI-RS resources per SNPN/CAG. The following table show an example of the distribution factor configured for each beam by SSB index per SNPN/CAG.

| Network | SSB | distribution/weight factor |
|---|---|---|
| SNPN #1: | SSB index 0 | 0.2 |
| distributionOnPagingOnly | SSB index 1 | 0.8 |
| SNPN #2 | SSB index 0 | 0.4 |
| | SSB index 1 | 0.2 |
| CAG #1 | SSB index 0 | 0.8 |
| distributionOnPagingOnly | SSB index 1 | 0.8 |

NW indicates that the distribution can only be triggered by paging for certain SNPN/CAGs. The following table shows an example of the distribution indication included in the paging message.

Distribution indication in the paging message

| | |
|---|---|
| SNPN #1 | Yes (indicated by “true” or “1” in a |
| | bitmap) |
| CAG #3 | No |

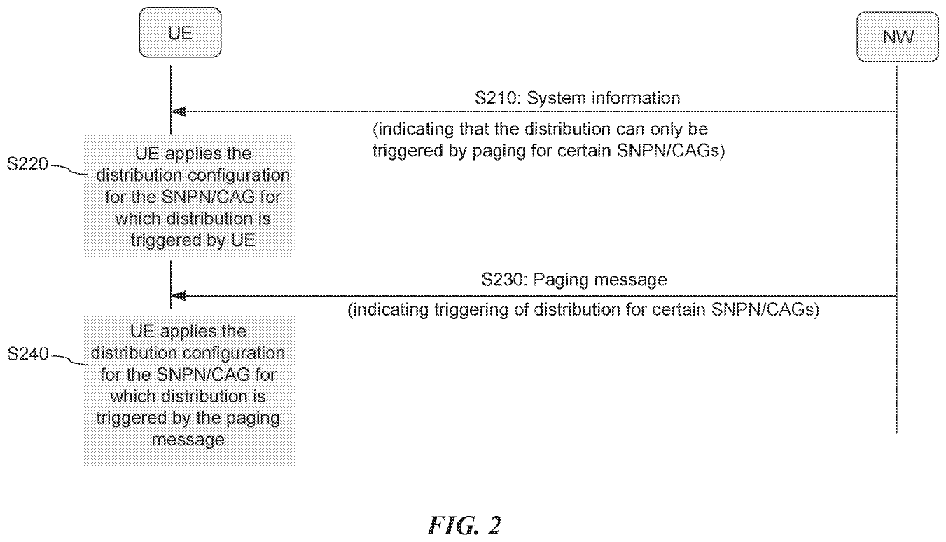

FIG. 2 illustrates a flowchart showing a procedure between UE and network (NW) based on some implementations of the disclosed technology.

At Step 1 (S210 in FIG. 2), UE receives the system information from NW. The system information includes the DistributionInfoPerNPNList which is used to indicate that the distribution for certain SNPN/CAG (e.g. SNPN #1 and CAG #3) can only be triggered by paging.

At Step 2 (S220 in FIG. 2), upon receiving the system information from NW, UE applies the distribution configuration to perform the distribution for the SNPN/CAG for which the distribution can be triggered by the UE. In this example, since the distribution for SNPN #2 can be triggered by UE itself, both nrofSS-BlocksToAverage and absThreshSS-BlocksConsolidation are configured and SSB #0 and SSB #1 are selected as good beams based on the absThreshSS-BlocksConsolidation, UE will use 0.4* the beam measurement quantity for SSB #0 and 0.2*the beam measurement quantity for SSB #1 in cell measurement quantity derivation.

At Step 3 (S230 in FIG. 2), NW triggers distribution for SNPN #1 via paging message.

At Step 4 (S240 in FIG. 1), the UE applies the distribution configuration to perform the distribution for the SNPN/CAG for which distribution operation is triggered by the paging message received at Step 3. Since both nrofSS-BlocksToAverage and absThreshSS-BlocksConsolidation are configured and SSB #0 and SSB #1 are selected as good beams based on the absThreshSS-BlocksConsolidation, for SNPN #1, UE will use 0.2* the beam measurement quantity for SSB #0 and 0.8*the beam measurement quantity for SSB #1 in cell measurement quantity derivation. Thus, since the distribution factor is configured per beam, UE multiplies the beam measurement quantity value with the corresponding distribution factor. UE derives the cell measurement quantity based on the multiplication of the beam measurement quantity value of each of the best beam or several good beams with the corresponding distribution factor. Then, UE uses the cell measurement quantity in sending measurement report, performing cell selection and reselection, evaluating conditional handover/conditional PSCell change condition, or determining the target for cell switch or cell group switch. After selecting or reselecting of a cell, UE may trigger small data transmission.

ASN.1 example 3-1: The distribution factors for SSB are configured per SNPN/CAG. Different SNPN/CAGs can configure different SSBs with different distribution factors.

| | |
|---|---|
| DistributionInfoPerNPNList ::= | SEQUENCE (SIZE (1..maxNPN)) OF |
| DistributionInfoPerNPN | |
| DistributionInfoPerNPN ::= | SEQUENCE (SIZE (1..maxSSB)) OF |
| DistributionInfoPerSSB | |
| DistributionInfoPerSSB ::= | SEQUENCE { |
| distributionFactor | ENUMERATED {oDot2, oDot4, oDot6, |
| oDot8} OPTIONAL | |
| } | |

ASN.1 Example 3-2: The distribution factors for SSB are configured per SNPN/CAG. Different SNPN/CAGs can configure different SSBs with different distribution factors.

| | |
|---|---|
| DistributionInfoPerNPNList ::= | SEQUENCE (SIZE (1..maxNPN)) OF |
| DistributionInfoPerNPN | |
| DistributionInfoPerNPN ::= | SEQUENCE (SIZE (1..maxSSB)) OF |
| DistributionInfoPerSSB | |
| DistributionInfoPerSSB ::= | SEQUENCE { |
| ssbIndex | INTEGER (0..maxSSB-1), |
| distributionFactor | ENUMERATED {oDot2, oDot4, oDot6, oDot8} |
| } | |

For all the ASN.1 Examples as mentioned above, the distribution factor can also be configured per CSI-RS resource id, per CSI-RS resource set id or per CSI-RS index for each CAG or SNPN.

ASN.1 Example 3-3: The indication showing that the distribution can only be triggered by paging for certain SNPN/CAGs.

| | |
|---|---|
| distronPagingOnlyBitmap | BIT STRING (SIZE (1...maxNPN)) |

The first/leftmost bit in this bitmap refers to the first SNPN/CAG in npn-IdentityInfoList, the second bit refers to the second SNPN/CAG in plmn-IdentityList, and so on. Value 1 indicates that distribution can only be triggered by paging for the corresponding SNPN/CAG.

ASN.1 Example 3-4: The indication showing that the distribution can only be triggered by paging for certainSNPN/CAGs.

| | |
|---|---|
| DistrOnPagingPerNPNList ::= | SEQUENCE (SIZE (1..maxPLMN)) OF |
| DistrOnPagingPerPerNPN | |
| DistrOnPagingPerPerNPN ::= | SEQUENCE { |
| distrOnPagingPerPerNPN | ENUMERATED {true} |
| OPTIONAL | |
| } | |

The first DistrOnPagingPerPerNPN in the DistrOnPagingPerNPNList refers to the first SNPN/CAG in npn-IdentityInfoList, the second DistrOnPagingPerPerNPN refers to the second NPN in npn-IdentityInfoList, and so on. For a certain SNPN/CAG with the distrOnPagingPerPerNPN set to true, the distribution can only be triggered by paging.

ASN.1 Example 2-5: The indication showing that the distribution can only be triggered by paging for certain SNPN/CAGs.

| | |
|---|---|
| DistronPagingPerNPNList ::= | SEQUENCE (SIZE (1..maxNPN)) OF |
| DistrOnPagingPerPerNPN | |
| DistrOnPagingPerPerNPN ::= | SEQUENCE { |
| npn-Index | INTEGER (1..maxNPN) |
| distrOnPagingPerPerNPN | ENUMERATED {true} |
| } | |

plmn-Index with value 1 refers to the first SNPN/CAG in npn-IdentityInfoList, the second bit refers to the second SNPN/CAG in npn-IdentityInfoList, and so on. For a certain SNPN/CAG with the distrOnPagingPerPerNPN set to true, the distribution can only be triggered by paging.

ASN.1 Example 2-6: The indication showing that the distribution can only be triggered by paging for certain SNPN/CAGs.

| | |
|---|---|
| DistrOnPagingPerNPNList ::= | SEQUENCE (SIZE (1..maxNPN)) OF |
| DistrOnPagingPerPerNPN | |
| DistrOnPagingPerNPN ::= | SEQUENCE { |
| npn-Identity | PLMN-Identity, |
| cag-Identit | BIT STRING (SIZE (32)) OPTIONAL, -- Need R |
| nid | BIT STRING (SIZE (44)) OPTIONAL, -- Need R |
| distrOnPagingPerPerNPN | ENUMERATED {true} |
| } | |

For a SNPN (identified by PLMN-Identity+nid) or a CAG (identified by PLMN-Identity+cag-Identity), if the distrOnPagingPerNPN is set to true, the distribution for this NPN can only be triggered by paging.

ASN.1 Example 2-7: The indication showing that the distribution can only be triggered by paging for a certain network type (e.g. SNPN or CAG).

| | |
|---|---|
| DistrOnPaging::= | SEQUENCE { |
| distronPagingSNPN | ENUMERATED {true} OPTIONAL, -- Need R |
| distronPagingCAG | ENUMERATED {true} OPTIONAL -- Need R |
| } | |

With distrOnPagingSNPN set to “true”, distribution for SNPNs configured with distribution targets and factors can only be triggered by paging.

With distrOnPagingCAG set to “true”, distribution for CAGs configured with distribution targets and factors can only be triggered by paging.

ASN.1 Example 2-8: The indication in paging message to trigger the distribution.

| | |
|---|---|
| Paging ::= | SEQUENCE { |
| distributionIndicationPerNPNlist | SEQUENCE (SIZE (1..maxNPN)) OF |
| DistributionIndicationPerNPN | |
| } | |
| DistributionIndicationPerNPN ::= | SEQUENCE { |
| npn-Index | INTEGER (1..maxNPN), |
| distriIndicationPerNPN | ENUMERATED {true} |
| } | |

In the paging message, if the distrOnPagingPerPerNPN is present and set to true for a certain SNPN/CAG, it indicates to trigger distribution procedure (i.e. UE use the distribution factor for each beam in cell measurement quantity derivation) for this SNPN/CAG.

ASN.1 Example 2-9: The indication in paging message to trigger the distribution.

| | |
|---|---|
| Paging ::= | SEQUENCE { |
| distriIndicationBitmap | BIT STRING (SIZE |
| (1...maxNPN)) OPTIONAL | |
| } | |

The first/leftmost bit in this bitmap refers to the first SNPN/CAG broadcast in npn-IdentityInfoList, the second bit in this bitmap refers to the second SNPN/CAG, and so on. For a certain SNPN/CAG, value “1” of the corresponding bit indicates to trigger distribution procedure (i.e. UE use the distribution factor for each beam in cell measurement quantity derivation) for this SNPN/CAG.

ASN.1 Example 2-10: The indication in paging message to trigger the distribution.

| | |
|---|---|
| Paging ::= | SEQUENCE { |
| distriIndicationSNPN | ENUMERATED {true} OPTIONAL, -- Need R |
| distriIndicationCAG | ENUMERATED {true} OPTIONAL -- Need R |
| } | |

DistriIndicationSNPN set to true indicates to trigger distribution procedure for SNPNs configured with distribution targets and factors.

DistriIndicationSNPN set to true indicates to trigger distribution procedure for SNPNs configured with distribution targets and factors.

### Implementation Example 4

A NTN cell configures neighbour Cells and/or frequencies with overlapped coverage as distribution targets for UEs and indicates that the distribution can only be triggered by NW via paging.

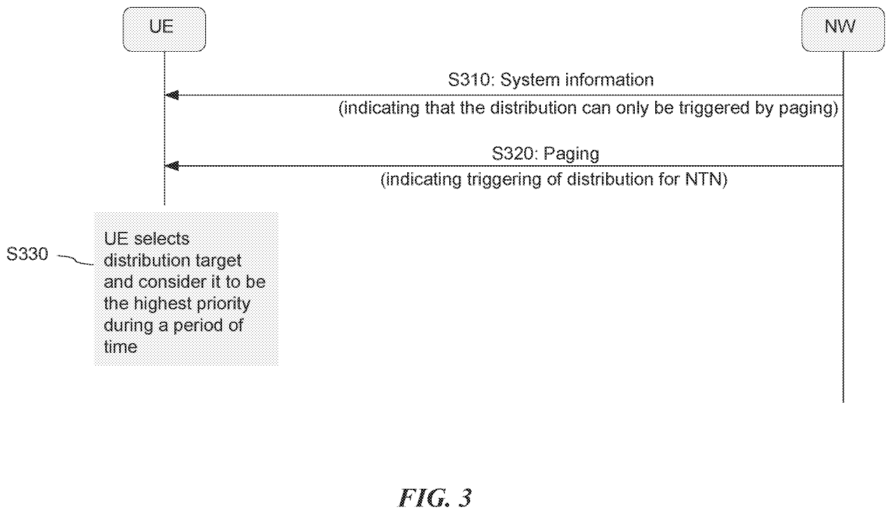

FIG. 3 illustrates a flowchart showing a procedure between UE and network (NW) based on some implementations of the disclosed technology.

At Step 1 (S310 in FIG. 3), UE receives the system information from NW. The system information includes the distributionServingInfoNTN and distributionInterFreqInfoNTN that are used to indicate that the distribution can only be triggered by paging.

At Step 2 (S320 in FIG. 3), NW triggers distribution for SNPN #1 via paging. In the example, UE starts Txxx with value set to txxx.

At Step 3 (S330 in FIG. 3), UE selects the distribution target and considers the distribution target (frequency or cell) as having the highest priority (i.e. higher than any network configured priority) before Txxx expires.

ASN.1 Example 4-1: The distributionServingInfoNTN and distributionInterFreqInfoNTN.

| distributionServingInfoNTN ::= | | SEQUENCE { |
|---|---|---|
| | distriFactorServingNTN | INTEGER(0..10), |
| | distriFactorCellNTN | ENUMERATED{true} |
| | OPTIONAL, --Need R | |

| | |
|---|---|
| txxx | ENUMERATED {min4, min8, min16, min32, infinity, |

| | |
|---|---|
| | spare3, spare2, spare1}, |
| distrOnPagingOnlyNTN | NUMERATED {true} OPTIONAL --Need R |

}

| InterFreqCarrierFreqInfo ::= | | SEQUENCE { |
|---|---|---|
| distributionInterFreqInfoNTN | | DistributionInterFreqInfoNTN OPTIONAL, |
| --Need R | | |
| } | | |
| DistributionInterFreqInfoNTN ::= | | SEQUENCE { |
| distributionFactorFreqNTN | DistributionFactor OPTIONAL, -- Need R | |
| distributionNeighCellListNTN | | DistributionNeighCellListNTN OPTIONAL-- |
| Need R | | |
| } | | |

| | |
|---|---|
| DistributionNeighCellListNTN ::= | SEQUENCE (SIZE (1..maxCellInter)) |

OF DistributionNeighCellNTN

| | |
|---|---|
| DistributionNeighCellNTN ::= | SEQUENCE { |

| | |
|---|---|
| physCellId | PhysCellId, |
| distributionFactorCellNTN | DistributionFactor |

}
DistributionFactor ::= INTEGER (1..10)

In this example, NW configures a combination of cells or frequencies as distribution targets. Upon receiving the distribution configuration from NW, the UE shall compile a sorted list of one or more candidate redistribution targets. For each candidate entry [j] maintained at UE side, a valid distrFactor[j], in which entries are added in increasing index order starting with index 0, is provided as follows:
For the serving frequency (distributionFactorServingNTN is included in system information whenever redistribution is configured): The candidate entry [0] is set to the serving cell if distributionFactorCellNTN is included and otherwise, candidate entry [0] is set to the serving frequency. In both cases, distrFactor[0] is set to distributionFactorServingNTN.
For each entry in InterFreqCarrierFreqList: The cell ranked as the best cell on this frequency according to R-criterion if distributionNeighCellListNTN is configured and includes this cell. Otherwise, the concerned frequency if distributionFactorFreqNTN is configured and if at least one cell on the frequency fulfills the cell selection S-criterion. If the cell is included, distrFactor[j] is set to the corresponding distributionFactorCellNTN1. If the frequency is included, distrFactor[j] is set to the corresponding distributionFactorFreqNTN.

The UE shall choose a distribution target as follows:
If ueID≤200*distriRange[0], the UE shall choose the frequency or the cell corresponding to distrFactor[0] as its redistribution target or;
If 200*Σⱼ₌₀^{j=i+1} distrRange[j]<ueID<200*Σⱼ₌₀^{j=1} distrRange[j], if then the UE shall choose the frequency or cell corresponding to distrFactor[i] as its redistribution target;
ueID=(5G−S−TMSI mod 100)*2+1

If there are no distribution candidates apart from the serving frequency or cell, the redistrRange[0]=1.

Otherwise, the distrRange[i] of NTN frequency or cell is defined by:

$$redistr Range [ i ] = \frac{redistr Factor [ i ]}{{\sum }_{j = 0}^{j = ( maxCandidates - 1 )} redistr Factor [ j ]}$$

Where: maxCandidates is the total number of frequencies/cells with valid distrFactor[j].

UE will consider the distribution target (frequency or cell) as having the highest priority (i.e. higher than any network configured priority) during cell selection and reselection for a period of time (UE starts Txxx upon receiving the paging to trigger the distribution procedure and set the value to txxx received in distributionServingInfoNTN. The redistribution target is considered as the highest priority before the Txxx expires). After selecting or reselecting of a cell, UE may trigger data transmission (e.g., small data transmission).

ASN.1 Example 4-2: Distribution indication in paging message.

| | |
|---|---|
| Paging ::= | SEQUENCE { |
| distributionIndicationNTN | ENUMERATED {true} OPTIONAL, |
| -- Need R | |
| } | |

The following table shows an example of the distribution indication included in a short message.

| Bit | Short Message |
|---|---|
| 1 | systemInfoModification |
| | If set to 1: indication of a BCCH modification other than SIB6, SIB7 and SIB8. |
| 2 | etwsAndCmasIndication |
| | If set to 1: indication of an ETWS primary notification and/or an ETWS secondary |
| | notification and/or a CMAS notification. |
| 3 | stopPagingMonitoring |
| | This bit can be used for only operation with shared spectrum channel access and if |
| | nrofPDCCH-MonitoringOccasionPerSSB-InPO is present. |
| | If set to 1: indication that the UE may stop monitoring PDCCH occasion(s) for |
| | paging in this Paging Occasion as specified in TS 38.304 [20], clause 7.1. |
| 4 | distributionIndication |
| | This bit can be used to trigger distribution procedure for NTN. |
| | If set to 1: indicate to trigger distribution procedure for NTN. |
| 5-8 | Not used in this release of the specification, and shall be ignored by UE if received. |

### Implementation Example 5

The distribution factor for each beam identified by reference signal, e.g. CSI-RS/SSB, is configured per cell or frequency for each measurement object. In the example, the distribution is triggered upon reception of the distribution configuration for conditional reconfiguration evaluation.

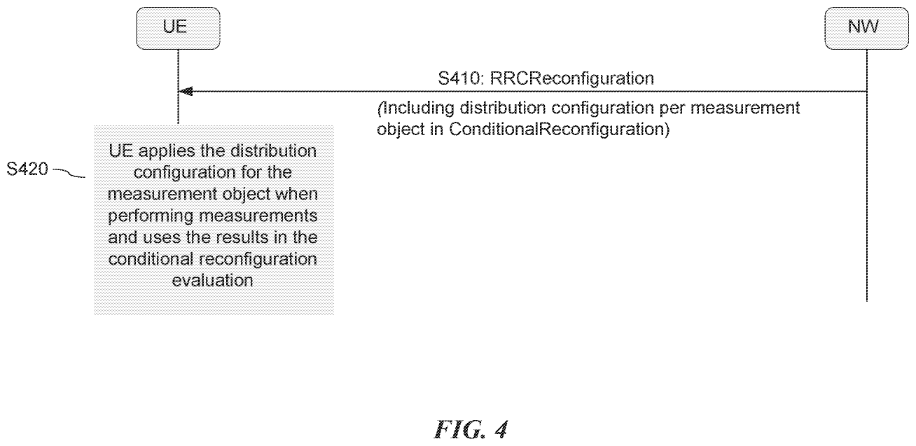

FIG. 4 illustrates a flowchart showing a procedure between UE and network (NW) based on some implementations of the disclosed technology.

At Step 1 (S410 in FIG. 4), UE receives the RRCReconfiguration message containing ConditionalReconfiguration from NW. The distribution factor for each beam identified by SS/PBCH block (SSB) or CSI-RS is configured per cell or per frequency in the ConditionalReconfiguration.

At Step 2 (S420 in FIG. 4), UE applies the distribution factor for each SSB/CSI-RS to derive the cell measurement quantity results, e.g. multiply the layer 3 filtered RSRP and RSRQ per beam for the concerned cell based on SSB/CSI-RS with the corresponding distribution factor to derive the cell measurement results and use the results in conditional reconfiguration evaluation.

ASN.1 Example 5-1: The distribution factors for CSI-RSs are configured per SSB index/CSI-RS index for each MO (Measurement object).

| | |
|---|---|
| MeasObjectNR ::= | SEQUENCE |
| Partly omitted | |
| referenceSignalConfig | ReferenceSignalConfig, |
| Partly omitted | |
| } | |
| ReferenceSignalConfig::= | SEQUENCE { |
| ssb-ConfigMobility | SSB-ConfigMobility |
| OPTIONAL, -- Need M | |
| csi-rs-ResourceConfigMobility | SetupRelease { CSI-RS- |
| ResourceConfigMobility } | OPTIONAL -- Need M |
| } | |
| SSB-ConfigMobility::= | SEQUENCE { |
| ssb-ToMeasure | SetupRelease { SSB-ToMeasure } |
| OPTIONAL, -- Need M | |
| deriveSSB-IndexFromCell | BOOLEAN, |
| ss-RSSI-Measurement | SS-RSSI-Measurement |
| OPTIONAL, -- Need M | |

distributionFactorSSB ENUMERATED {oDot2, oDot4, oDot6, oDot8}

| | |
|---|---|
| OPTIONAL | |
| Partly omitted | |
| } | |
| CSI-RS-ResourceConfigMobility ::= | SEQUENCE { |
| subcarrierSpacing | SubcarrierSpacing, |
| csi-RS-CellList-Mobility | SEQUENCE (SIZE (1..maxNrofCSI-RS- |

CellsRRM)) OF CSI-RS-CellMobility,

| | |
|---|---|
| ..., | |
| [[ | |
| refServCellIndex | ServCellIndex |
| OPTIONAL -- Need S | |
| ]] | |
| } | |
| CSI-RS-CellMobility ::= | SEQUENCE { |
| cellId | PhysCellId, |
| csi-rs-MeasurementBW | SEQUENCE { |
| nrofPRBs | ENUMERATED { size24, size48, size96, |
| size192, size264}, | |
| startPRB | INTEGER(0..2169) |
| }, | |
| density | ENUMERATED {d1, d3} |
| OPTIONAL, -- Need R | |
| csi-rs-ResourceList-Mobility | SEQUENCE (SIZE (1..maxNrofCSI-RS- |

ResourcesRRM)) OF CSI-RS-Resource-Mobility
}

| | |
|---|---|
| CSI-RS-Resource-Mobility ::= | SEQUENCE { |
| csi-RS-Index | CSI-RS-Index, |
| slotConfig | CHOICE { |
| ms4 | INTEGER (0..31), |
| ms5 | INTEGER (0..39), |
| ms10 | INTEGER (0..79), |
| ms20 | INTEGER (0..159), |
| ms40 | INTEGER (0..319) |
| }, | |
| associatedSSB | SEQUENCE { |
| ssb-Index | SSB-Index, |
| isQuasiColocated | BOOLEAN |
| } | |
| OPTIONAL, -- Need R | |
| frequencyDomainAllocation | CHOICE { |
| row1 | BIT STRING (SIZE (4)) , |
| row2 | BIT STRING (SIZE (12)) |
| }, | |
| firstOFDMSymbolInTimeDomain | INTEGER (0..13) , |
| sequenceGenerationConfig | INTEGER (0..1023), |
| DistributionFactorCSI-RS | ENUMERATED {oDot2, oDot4, oDot6, oDot8} |
| OPTIONAL | |
| } | |
| CSI-RS-Index ::= | INTEGER (0..maxNrofCSI-RS-Resources RRM-1 |

### Implementation Example 7

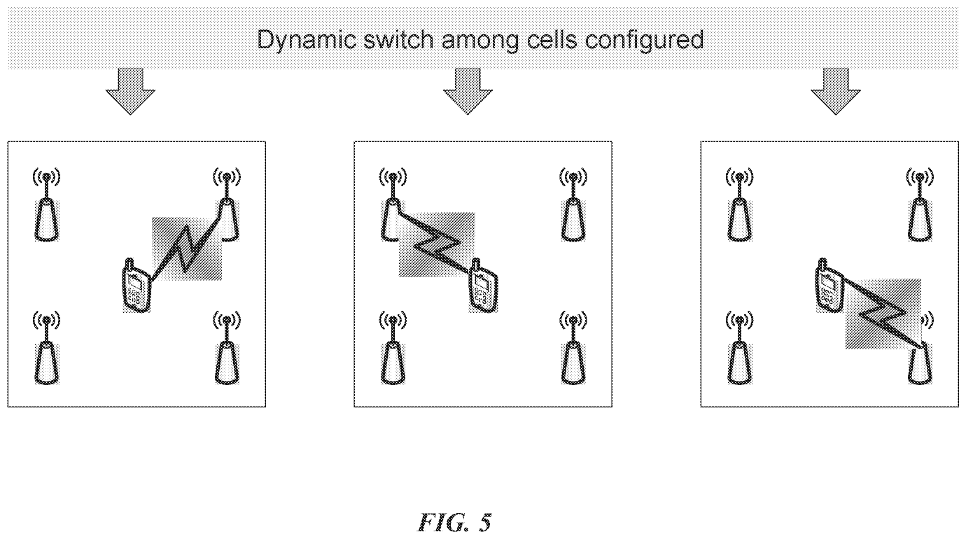

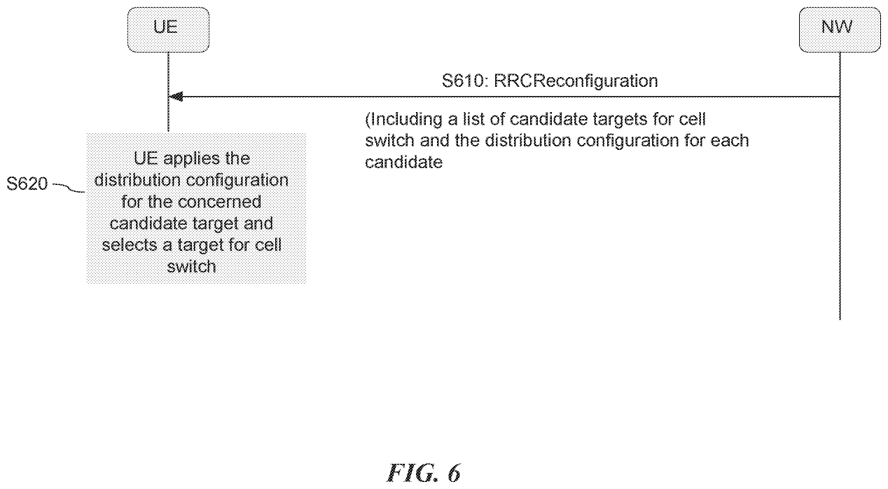

FIG. 5 shows an example of a dynamic switch among cells configured. As shown in FIG. 5, the UE performs the dynamic switch from the original cell to another cell. FIG. 6 illustrates a flowchart showing a procedure between UE and network (NW) based on some implementations of the disclosed technology.

At Step 1 (S610 in FIG. 6), UE receives the RRCReconfiguration message containing a list of candidate target cells (with the radio resource configuration provided for each cell) for dynamic switch and the distribution configuration for each candidate target cell. For each candidate cell, a distribution/weight factor can be configured. For each candidate cell, a distribution/weight factor can be configured per beam identified by reference signals, e.g. SSB index/CSI-RS index.

At Step 2 (S620 in FIG. 6), UE applies the distribution configuration for the concerned target cell and selects a target for dynamic cell switch. For each candidate cell, execution condition (e.g. RSRP/RSRQ threshold(s)) for switch to this cell may also be configured. UE will multiply the cell measurement results with the distribution/weight factor configured for this cell and UE will use the multiplied value when evaluating the execution condition. UE will multiply the layer 3 filtered RSRP and RSRQ per beam with the distribution factor configured for each beam identified by reference signals, e.g. SSB/CSI-RS, for the concerned cell to derive the cell measurement result to be used when evaluating the execution condition. RSRP/RSRQ thresholds for the qualified candidate cells can be configured and UE will report the qualified cells to NW. NW will indicate a target for dynamic switch via L1/L2/L3 signaling and UE will select the indicated cell.

In some implementations, UE will multiply the cell measurement results with the distribution/weight factor configured for this cell and UE will use the multiplied value when evaluating whether the concerned cell is qualified or not. In some implementations, UE will multiply the layer 3 filtered RSRP and RSRQ per beam with the distribution factor configured for each beam identified by reference signals, e.g. SSB/CSI-RS for the concerned cell to derive the cell measurement result to be used when evaluating whether the concerned cell is qualified or not. In some implementations, the L1 signaling to indicate the target for dynamic switch can be a DCI, the L2 signaling for such indication can be MAC CE, and/or the L3 signaling for such indication can be a dedicated RRC message, e.g. CellSwitchCommand message or RRCReconfiguration message.

### Implementation Example 8

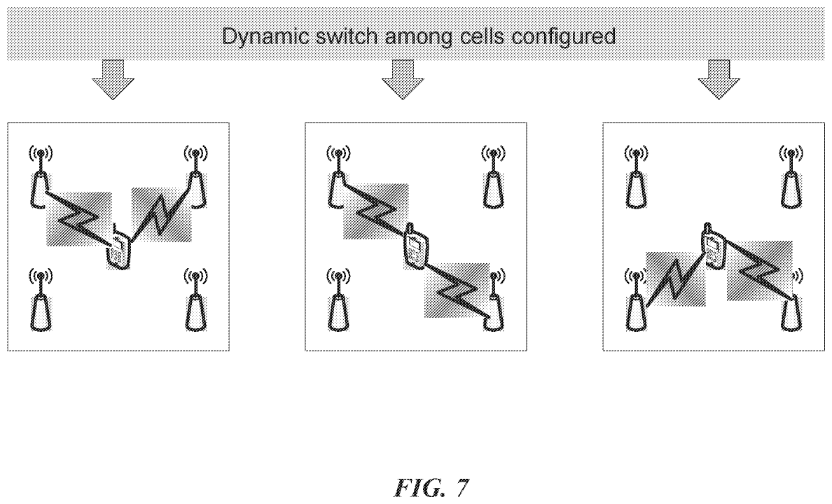

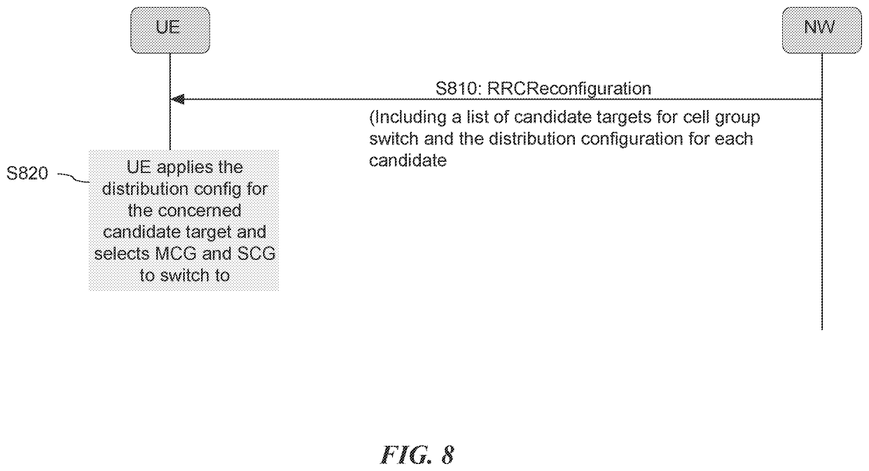

FIG. 7 shows an example of a dynamic switch among cells configured. As shown in FIG. 5, the UE performs the dynamic switch by selecting the master cell group (MCG) and the secondary cell group (SCG). FIG. 8 illustrates a flowchart showing a procedure between UE and network (NW) based on some implementations of the disclosed technology.

At Step 1 (S810 in FIG. 8), UE receives the RRCReconfiguration message containing a list of candidate target cell groups (with the radio resource configuration provided for each cell group) for dynamic switch and the distribution configuration for each candidate target cell group. Only two cell groups can be activated at the same time as MCG and SCG separately. For each candidate cell group, a distribution/weight factor can be configured. For each cell in the candidate cell group, a distribution/weight factor can be configured. For each cell in the candidate cell group, a distribution/weight factor can be configured per beam identified by reference signals, e.g. SSB/CSI-RS.

At Step 2 (S820 in FIG. 8), UE applies the distribution configuration for the concerned target cell group and select MCG and SCG to switch to. For each candidate cell group, execution condition (e.g. RSRP/RSRQ threshold(s)) for switch to this cell group as a MCG or SCG may be configured, UE will switch to the concerned MCG and/or SCG when all the cells within the execution condition is fulfilled for all the cells within the concerned CG or the execution condition is fulfilled for at least one cell within the concerned CG.

For the case when the distribution/weight factor is configured per cell group, UE will multiply the cell measurement results for all the cells in the concerned cell group with the distribution/weight factor configured for this cell group and use the multiplied value when evaluating the execution condition. For the case when the distribution/weight factor is configured per cell for cells in the concerned cell group, UE will then multiply the cell measurement result for each cell with the configured distribution/weight factor and use the multiplied value when evaluating the execution condition. For the case when the distribution/weight factor is configured per beam for cells in the concerned cell group, UE will multiply the layer 3 filtered RSRP and RSRQ per beam with the distribution factor configured for each beam identified by reference signals, e.g. SSB/CSI-RS, for the concerned cell to derive the cell measurement result to be used when evaluating the execution condition. RSRP/RSRQ thresholds for the qualified candidate MCGs and SCGs can be configured and UE will report the qualified cell groups to NW. NW will indicate target MCG and/SCG for dynamic switch via L1/L2/L3 signaling and UE will activate the indicated MCG and/or SCG then. For the case when the distribution/weight factor is configured per cell group, UE will multiply the cell measurement results for all the cells in the concerned cell group with the distribution/weight factor configured for this cell group and use the multiplied value when evaluating whether the CG is qualified or not. For the case when the distribution/weight factor is configured per cell for cells in the concerned cell group, UE will then multiply the cell measurement result for each cell with the configured distribution/weight factor and use the multiplied value when evaluating whether the CG is qualified or not. For the case when the distribution/weight factor is configured per beam for cells in the concerned cell group, UE will multiply the layer 3 filtered RSRP and RSRQ per beam with the distribution/weight factor configured for each beam identified by reference signals, e.g. SSB/CSI-RS, for the concerned cell to derive the cell measurement result to be used when evaluating whether the CG is qualified or not.

One candidate MCG or SCG can be considered to be qualified when the RSRP/RSRQ of all the cells within the concerned CG is larger than or equal to the threshold or when at least one cell within the concerned CG for which the RSRP/RSRQ is above the threshold. In some implementations, the L1 signaling to indicate the target for dynamic cell group switch can be a DCI, the L2 signaling for such indication can be MAC CE, and/or the L3 signaling for such indication can be a dedicated RRC message, e.g. CellSwitchCommand.

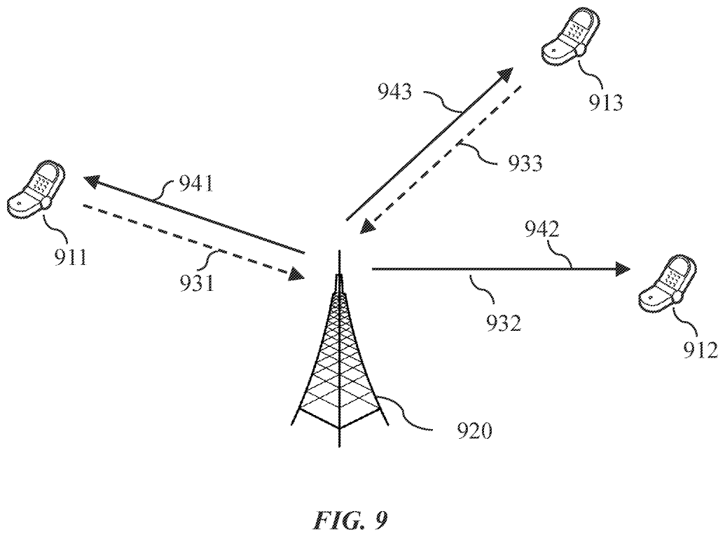

The implementations as discussed above will apply to a wireless communication. FIG. 9 shows an example of a wireless communication system (e.g., a 5G or NR cellular network) that includes a base station 920 and one or more user equipment (UE) 911, 912 and 913. In some embodiments, the UEs access the BS (e.g., the network) using implementations of the disclosed technology 931, 932, 933), which then enables subsequent communication (941, 942, 943) from the BS to the UEs. The UE may be, for example, a smartphone, a tablet, a mobile computer, a machine to machine (M2M) device, an Internet of Things (IoT) device, and so on.

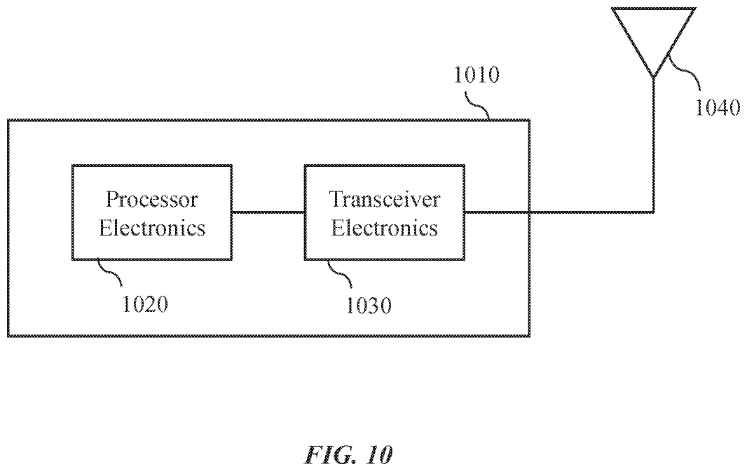

FIG. 10 shows an example of a block diagram representation of a portion of an apparatus. An apparatus 1010 such as a base station or a user device which may be any wireless device (or UE) can include processor electronics 1020 such as a microprocessor that implements one or more of the techniques presented in this document. The apparatus 1010 can include transceiver electronics 1030 to send and/or receive wireless signals over one or more communication interfaces such as antenna 1040. The apparatus 1010 can include other communication interfaces for transmitting and receiving data. The apparatus 1010 can include one or more memories (not explicitly shown) configured to store information such as data and/or instructions. In some implementations, the processor electronics 1020 can include at least a portion of transceiver electronics 1030. In some embodiments, at least some of the disclosed techniques, modules or functions are implemented using the apparatus 1010.

Additional features of the above-described methods/techniques that may be preferably implemented in some implementations are described below using a clause-based description format.

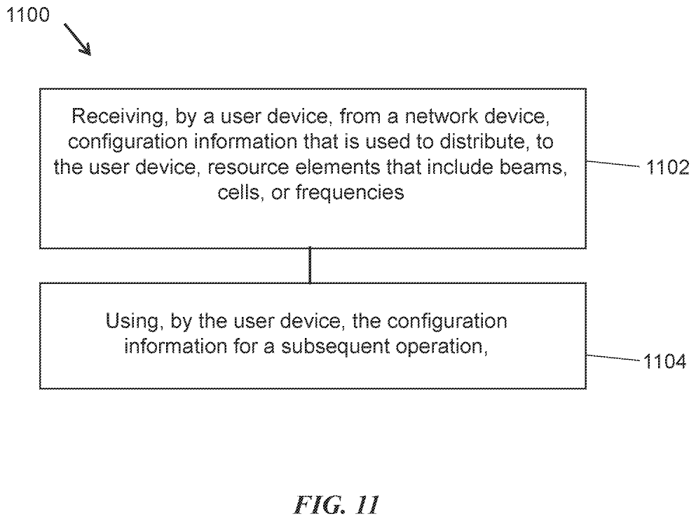

1. A method of wireless communication (e.g., method 1100 as shown in FIG. 11), comprising: receiving 1102, by a user device, from a network device, configuration information that is used to distribute, to the user device, resource elements that include beams, cells, or frequencies; and using 1104, by the user device, the configuration information for a subsequent operation, wherein the configuration information includes at least one of i) one or more lists of distribution targets, ii) one or more distribution factors, each distribution factor giving a weight of a corresponding distribution target, or iii) a timer configured with the one or more distribution targets or the one or more distribution factors.

2. The method of clause 1, wherein each distribution target is a beam, a cell, a cell group, or a frequency.

3. The method of clause 1, wherein the distribution configuration information includes an indication indicating whether the subsequent operation is triggered by the user device or by the network.

4. The method of clause 3, wherein the indication is an one-bit indication to trigger the subsequent operation or a list of indications, each indication triggering the subsequent operation under a certain slice, a slice group, a access category, an access category group, a stand-alone non-public network (SNPN), a public land mobile network (PLMN), or a closed access group (CAG), a certain network type, or a certain network scenario.

5. The method of clause 1, further comprising receiving, from the network device, a paging message, a dedicated radio resource control (RRC) message, a MAC control element (CE) or a downlink control information (DCI) to trigger the subsequent operation based on the configuration information.

6. The method of clause 1, further comprising: applying the one or more distribution factors in deriving cell measurement information and/or selecting a distribution target.

7. The method of clause 1, wherein the subsequent operation includes sending measurement report, or performing a cell selection or a cell reselection, or evaluating a execution condition for a conditional handover or conditional Primary SCG (Secondary Cell Group) Cell (PSCell) change, or determining a target for cell switch or cell group switch.

8. The method of clause 7, further comprising, after the performing of the cell selection or the cell reselection, triggering data transmission.

9. The method of clause 1, wherein the distribution target is identified by a reference signal for the beam, by a physical cell identification for the cell, or an absolute radio-frequency channel number (ARFCN) value for the frequency.

10. The method of clause 1, wherein the one or more lists of the distribution targets are configured such that each list is for a certain slice, a slice group, an access category, an access category group, a non-public network (NPN), a stand-alone non-public network (SNPN), a public land mobile network (PLMN), or a closed access group (CAG).

11. The method of clause 1, wherein the one or more lists of the distribution targets are configured for a certain network type or a certain network scenario that includes a stand-alone non-public network (SNPN), a closed access group (CAG) network, a non-public network (NPN), a terrestrial network, a non-terrestrial network, a non-terrestrial network served by a geostationary (GEO) satellite, a non-terrestrial network served by a non-GEO satellite, a non-terrestrial network served by a medium earth orbit (MEO) satellite, a non-terrestrial network served by a low earth orbit (LEO) satellite, a non-terrestrial network served by a high altitude platform station (HAPS), a non-terrestrial network with fixed beam scenario or a non-terrestrial network with moving beam scenario.

12. The method of clause 1, wherein more than one distribution factors are configured such that each distribution factor is for a certain slice, a slice group, an access category, an access category group, a non-public network (NPN), a stand-alone non-public network (SNPN), a public land mobile network (PLMN), a closed access group (CAG), a certain network type or a certain network scenario.

13. The method of clause 1, wherein the configuration information is received by the user device via a system information block or a radio resource control (RRC) message.

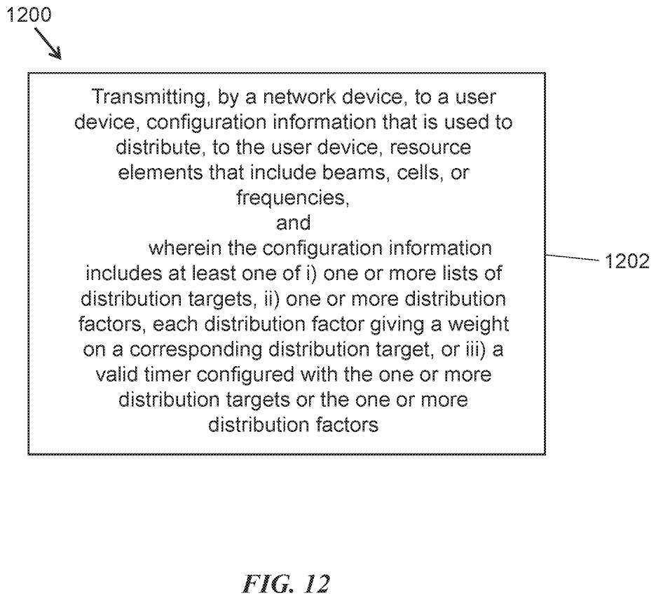

14. A method of wireless communication (e.g., method 1200 as shown in FIG. 12), comprising: transmitting 1202, by a network device, to a user device, configuration information that is used to distribute, to the user device, resource elements that include beams, cells, or frequencies, and wherein the configuration information includes at least one of i) one or more lists of distribution targets, ii) one or more distribution factors, each distribution factor giving a weight on a corresponding distribution target, or iii) a valid timer configured with the one or more distribution targets or the one or more distribution factors.

15. The method of clause 14, wherein each distribution target is a beam, a cell, a cell group, or a frequency.

16. The method of clause 14, wherein the distribution configuration information includes an indication indicating whether a subsequent operation is triggered by the network or the user device.

17. The method of clause 16, wherein the indication is an one-bit indication to trigger the subsequent operation or a list of indications, each indication triggering the subsequent operation under a certain slice, a slice group, a access category, an access category group, a non-public network (NPN), a stand-alone non-public network (SNPN), a public land mobile network (PLMN), or a closed access group (CAG), a certain network type, or a certain network scenario.

18. The method of clause 14, further comprising transmitting, by the network device, a message to trigger the user device to perform a subsequent operation based on the configuration information.

19. The method of clause 18, wherein the message is transmitted via a downlink control information (DCI) or a paging message.

20. The method of clause 14, wherein the distribution target is identified by a reference signal for the beam, by a physical cell identification for the cell, or an absolute radio-frequency channel number (ARFCN) value for the frequency.

21. The method of clause 14, wherein the one or more lists of the distribution targets are configured such that each list is for a certain slice, a slice group, an access category, an access category group, a non-public network (NPN), a stand-alone non-public network (SNPN), a public land mobile network (PLMN), or a closed access group (CAG).

22. The method of clause 14, wherein the one or more lists of the distribution targets are configured for a certain network type or a certain network scenario that includes a non-public network (NPN), a stand-alone non-public network (SNPN), a closed access group (CAG) network, a terrestrial network, a non-terrestrial network, a non-terrestrial network served by a geostationary (GEO) satellite, a non-terrestrial network served by a non-GEO satellite, a non-terrestrial network served by a medium earth orbit (MEO) satellite, a non-terrestrial network served by a low earth orbit (LEO) satellite, a non-terrestrial network served by a high altitude platform station (HAPS), a non-terrestrial network with fixed beam scenario or a non-terrestrial network with moving beam scenario.

23. The method of clause 14, wherein more than one distribution factors are configured such that each distribution factor is for a certain slice, a slice group, an access category, an access category group, a non-public network (NPN), a stand-alone non-public network (SNPN), a public land mobile network (PLMN), a closed access group (CAG), a certain network type or a certain network scenario.

24. The method of clause 14, wherein the configuration information is transmitted via a system information block or a radio resource control (RRC) message.

25. A communication apparatus comprising a processor configured to implement a method recited in any one or more of clauses 1 to 24.

26. A computer readable medium having code stored thereon, the code, when executed, causing a processor to implement a method recited in any one or more of clauses 1 to 24.

It is intended that the specification, together with the drawings, be considered exemplary only, where exemplary means an example and, unless otherwise stated, does not imply an ideal or a preferred embodiment. As used herein, the use of “or” is intended to include “and/or”, unless the context clearly indicates otherwise.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a user device, from a network device, configuration information that is used to distribute, to the user device, resource elements that include beams, cells, or frequencies; and
using, by the user device, the configuration information for a subsequent operation,
wherein the configuration information includes at least one of i) one or more lists of distribution targets, ii) one or more distribution factors, each distribution factor giving a weight of a corresponding distribution target, or iii) a timer configured with the one or more distribution targets or the one or more distribution factors.

2. The method of claim 1, wherein each distribution target is a beam, a cell, a cell group, or a frequency.

3. The method of claim 1, wherein the distribution configuration information includes an indication indicating whether the subsequent operation is triggered by the user device or by the network.

4. The method of claim 3, wherein the indication is a one-bit indication to trigger the subsequent operation or a list of indications, each indication triggering the subsequent operation under a certain slice, a slice group, an access category, an access category group, a stand-alone non-public network (SNPN), a public land mobile network (PLMN), or a closed access group (CAG), a certain network type, or a certain network scenario.

5. The method of claim 1, further comprising receiving, from the network device, a paging message, a dedicated radio resource control (RRC) message, a MAC control element (CE) or a downlink control information (DCI) to trigger the subsequent operation based on the configuration information.

6. The method of claim 1, further comprising: applying the one or more distribution factors in deriving cell measurement information and/or selecting a distribution target.

7. The method of claim 1, wherein the subsequent operation includes sending measurement report, or performing a cell selection or a cell reselection, or evaluating a execution condition for a conditional handover or conditional Primary SCG (Secondary Cell Group) Cell (PSCell) change, or determining a target for cell switch or cell group switch.

8. The method of claim 7, further comprising, after the performing of the cell selection or the cell reselection, triggering data transmission.

9. The method of claim 1, wherein the distribution target is identified by a reference signal for the beam, by a physical cell identification for the cell, or an absolute radio-frequency channel number (ARFCN) value for the frequency.

10. The method of claim 1, wherein the one or more lists of the distribution targets are configured such that each list is for a certain slice, a slice group, an access category, an access category group, a non-public network (NPN), a stand-alone non-public network (SNPN), a public land mobile network (PLMN), or a closed access group (CAG).

11. The method of claim 1, wherein the one or more lists of the distribution targets are configured for a certain network type or a certain network scenario that includes a stand-alone non-public network (SNPN), a closed access group (CAG) network, a non-public network (NPN), a terrestrial network, a non-terrestrial network, a non-terrestrial network served by a geostationary (GEO) satellite, a non-terrestrial network served by a non-GEO satellite, a non-terrestrial network served by a medium earth orbit (MEO) satellite, a non-terrestrial network served by a low earth orbit (LEO) satellite, a non-terrestrial network served by a high altitude platform station (HAPS), a non-terrestrial network with fixed beam scenario or a non-terrestrial network with moving beam scenario.

12. The method of claim 1, wherein more than one distribution factors are configured such that each distribution factor is for a certain slice, a slice group, an access category, an access category group, a non-public network (NPN), a stand-alone non-public network (SNPN), a public land mobile network (PLMN), a closed access group (CAG), a certain network type or a certain network scenario.

13. The method of claim 1, wherein the configuration information is received by the user device via a system information block or a radio resource control (RRC) message.

14. A method of wireless communication, comprising:
transmitting, by a network device, to a user device, configuration information that is used to distribute, to the user device, resource elements that include beams, cells, or frequencies, and
wherein the configuration information includes at least one of i) one or more lists of distribution targets, ii) one or more distribution factors, each distribution factor giving a weight on a corresponding distribution target, or iii) a valid timer configured with the one or more distribution targets or the one or more distribution factors.

15. The method of claim 14, wherein each distribution target is a beam, a cell, a cell group, or a frequency.

16. The method of claim 14, wherein the distribution configuration information includes an indication indicating whether a subsequent operation is triggered by the network or the user device.

17. The method of claim 16, wherein the indication is an one-bit indication to trigger the subsequent operation or a list of indications, each indication triggering the subsequent operation under a certain slice, a slice group, a access category, an access category group, a non-public network (NPN), a stand-alone non-public network (SNPN), a public land mobile network (PLMN), or a closed access group (CAG), a certain network type, or a certain network scenario.

18. The method of claim 14, further comprising transmitting, by the network device, a message to trigger the user device to perform a subsequent operation based on the configuration information.

19. The method of claim 18, wherein the message is transmitted via a downlink control information (DCI) or a paging message.

20. An apparatus comprising a processor configured to implement a method, the method comprising:
transmitting configuration information that is used to distribute, to a user device, resource elements that include beams, cells, or frequencies,
wherein the configuration information includes at least one of i) one or more lists of distribution targets, ii) one or more distribution factors, each distribution factor giving a weight on a corresponding distribution target, or iii) a valid timer configured with the one or more distribution targets or the one or more distribution factors.
